(19) United States
(12) Patent Application Publication
(10) Pub. No.: US 2011/0320612 A1
(43) Pub. Date: Dec. 29, 2011

(54) ELECTRONIC APPARATUS, WIRELESS DEVICE, AND COMMUNICATION CONTROL METHOD

(75) Inventors: Hiroyuki Oka, Hino-shi (JP); Ryo Hatano, Kodaira-shi (JP); Hirotada Hirabayashi, Hamura-shi (JP); Kotaro Fukui, Hamura-shi (JP); Masaharu Nakatsuchi, Yokohama-shi (JP); Toshiyuki Suzuki, Yokohama-shi (JP)

(73) Assignees: NTT DOCOMO, INC., Tokyo (JP); KABUSHIKI KAISHA TOSHIBA, Tokyo (JP)

(21) Appl. No.: 13/168,750

(22) Filed: Jun. 24, 2011

(30) Foreign Application Priority Data
Jun. 24, 2010 (JP) 2010-144124

(51) Int. Cl. G06F 15/16

(52) U.S. Cl. 709/227

(57) ABSTRACT

According to one embodiment, an electronic apparatus comprises a communication device, a first controller, a second controller, and a player. The communication device has a close proximity wireless communication function. The first controller establishes connection between a wireless device and the communication device in a proximity state. The second controller connects the electronic apparatus to a server through the close proximity wireless communication function and a wireless communication function of the wireless device. The player plays a content received from the server through the close proximity wireless communication function and the wireless communication function of the wireless device, to halt playing the content when the proximity state is released during the playing, and resume playing the content when the proximity state is restored.

### CROSS-REFERENCE TO RELATED APPLICATIONS

This application is based upon and claims the benefit of priority from Japanese Patent Application No. 2010-144124, filed Jun. 24, 2010; the entire contents of which are incorporated herein by reference.

### FIELD

Embodiments described herein relate generally to an electronic apparatus executing close proximity wireless communication, a wireless device, and a communication control method for controlling the close proximity wireless communication.

### BACKGROUND

Recently, a cell-phone and IC card have used wireless communication such as near field communication (NFC). A user can easily make communication for authentication, accounting, and other services simply by placing a cell-phone or IC card over a reader/writer of a host system.

Lately, close proximity wireless communication for high-speed communications has been developed. This new communication technology enables exchanging a large-capacity data files of documents and audio/visual data between devices, as well as authentication and accounting service.

Usually, a timeout parameter is used in an NFC communication session. As a timeout parameter, there are a timeout value to determine whether a physical connection is disconnected, and a timeout value to recover a disconnected connection.

In close proximity wireless communication, connection between devices is established by moving the devices close to each other, and a desired service can be started. Connection between devices is released by moving the devices away from each other. Therefore, if a proximity state between devices is released during execution of service by a displacement between devices or movement of a device by a user, it causes an error, and a service is not normally completed.

In the future, close proximity wireless communication will be widely used in various kinds of devices and services. In some kinds of service, the above-mentioned error may degrade the operability of close proximity wireless communication. Therefore, new technology is demanded to deal with such an error.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of configuration of a network access system realized by using an electronic apparatus according to an embodiment.

FIG. 2 is an exemplary block diagram showing a system configuration of the electronic apparatus of the embodiment.

FIG. 3 is an exemplary block diagram showing a configuration of a communication control program used in the electronic apparatus of the embodiment.

FIG. 4 is an exemplary perspective view showing an external view of the electronic apparatus of the embodiment.

FIG. 5 is an exemplary diagram showing an example of close proximity wireless communication executed between an external device and the electronic apparatus of the embodiment.

FIG. 6 shows an example of connection management screen used in the electronic apparatus of the embodiment.

FIG. 7 shows an example of a setup screen used in the electronic apparatus of the embodiment.

FIG. 8 shows an example of a playback screen displayed by a player application of the electronic apparatus of the embodiment.

FIG. 9 is an exemplary flowchart of procedures executed by a connection management tool of the electronic apparatus of the embodiment.

FIG. 10 is an exemplary flowchart of procedures executed by a player application of the electronic apparatus of the embodiment.

FIG. 11 is an exemplary block diagram showing a configuration of a wireless device according to an embodiment.

FIG. 12 is an exemplary flowchart explaining procedures of communication control executed by the wireless device of FIG. 11.

### DETAILED DESCRIPTION

Various embodiments will be described hereinafter with reference to the accompanying drawings.

In general, according to one embodiment, an electronic apparatus comprises a communication device, a first controller, a second controller, and a player. The communication device has a close proximity wireless communication function. The first controller establishes connection between a wireless device and the communication device in a proximity state. The second controller connects the electronic apparatus to a server through the close proximity wireless communication function and a wireless communication function of the wireless device. The player plays a content received from the server through the close proximity wireless communication function and the wireless communication function of the wireless device, to halt playing the content when the proximity state is released during the playing, and resume playing the content when the proximity state is restored.

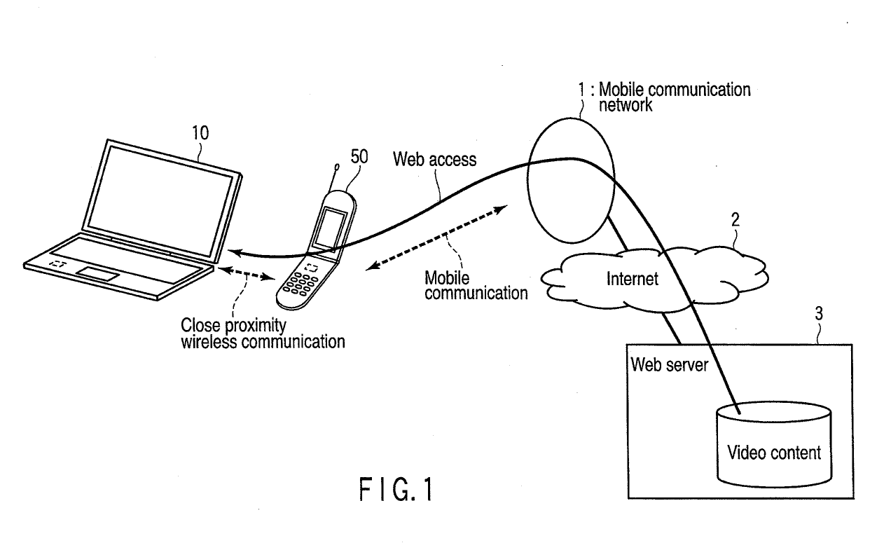

FIG. 1 shows an example of configuration of a network access system realized by using an electronic apparatus and wireless device according to an embodiment. An electronic apparatus 10 is realized as a portable computer, an audio player, or a television, for example. The electronic apparatus 10 comprises a communication module for executing close proximity wireless communication, establishes wireless connection with another device (an external device) having a close proximity wireless communication function, and executes close proximity wireless communication with an external device in peer-to-peer fashion. Close proximity wireless communication can be used only when the electronic apparatus 10 and external device are in a proximity state. The external device comprises a wireless device such as a cell-phone 50, for example. The wireless device 50 has a wireless communication function for mobile communication, and can be wirelessly connected to a mobile communication network 1 such as a cell-phone network. The wireless device 50 also has a close proximity wireless communication function similar to the electronic apparatus 10.

The electronic apparatus 10 can use the wireless device 50 as a modem for connecting to an external network such as Internet 2. For example, the electronic apparatus 10 can access a Web server 3 on the Internet 2 through the close proximity wireless communication with the wireless device 50 and the wireless communication function (mobile communication function) of the wireless device 50. The electronic apparatus 10 can play content (e.g. video data) received from the Web server 3 (streaming), while receiving the content through the close proximity wireless communication and the wireless communication function of the wireless device 50. The electronic apparatus 10 can also play audio data such as music received from the Web server 3, as sell as video data, while receiving the audio data from the Web server 3 by streaming. In addition to video and audio data, the electronic apparatus 10 can receive other various contents (e.g. still picture and Web content) from the Web server 3 through the close proximity wireless communication and the wireless communication function of the wireless device 50, and process the received content.

The wireless device 50 connects to the Web server 3 on the Internet 2 through the mobile communication network 1, upon request of the electronic apparatus 10, and transfers the content received from the Web server 3 to the electronic apparatus 10 through close proximity wireless communication.

A proximity state between the electronic apparatus 10 and wireless device 50 may be released during playback of content such as video data by the following factors, for example.

One factor is a displacement in the positions of the electronic apparatus 10 and wireless device 50. Another factor is that the wireless device 50 may be temporarily moved away from the electronic apparatus 10 by the user during playing of content such as video data. For example, when the wireless device 50 receives an incoming call during playback of content such as video data, the user may pick up and operate the wireless device 50 to answer the call. At this time, the proximity state between the electronic apparatus 10 and wireless device 50 may be released.

When the proximity state is released, the connection between the electronic apparatus 10 and wireless device 50 is usually disconnected. Therefore, a release of the proximity state is almost the same as a sudden removal of a modem from the electronic apparatus 10. A communication application operating on the electronic apparatus 10 may display a warning of a communication error, and stop the communication. In this case, usually, the electronic apparatus 10 and wireless device 50 must be re-connected from the first step. Otherwise, the electronic apparatus 10 cannot access the Web server 3 on the Internet 2.

In this embodiment, a communication application (e.g. a player application) operating on the electronic apparatus 10 can appropriately control a play operation depending on the state of connection between the electronic apparatus 10 and wireless device 50. More specifically, when the proximity state between the electronic apparatus 10 and wireless device 50 is released, the player application automatically halts playing content such as video data (pause). When the proximity state between the electronic apparatus 10 and wireless device 50 are restored, the player application restarts playing the content. During the pause period, the player application needs not to receive content such as video data from the Web serve 3. Therefore, even if data transfer by close proximity wireless communication is stopped, the operation of the player application is not adversely affected.

Therefore, even if the proximity state between the electronic apparatus 10 and wireless device 50 is temporarily released during playback of content such as video data, a communication error of the player application does not occur, and the connection between the electronic apparatus 10 and Web server 3 through the wireless device 50 can be kept. Therefore, playback of content such as video data can be easily resumed, preventing degradation in the operability of close proximity wireless communication caused by a temporary release of proximity state.

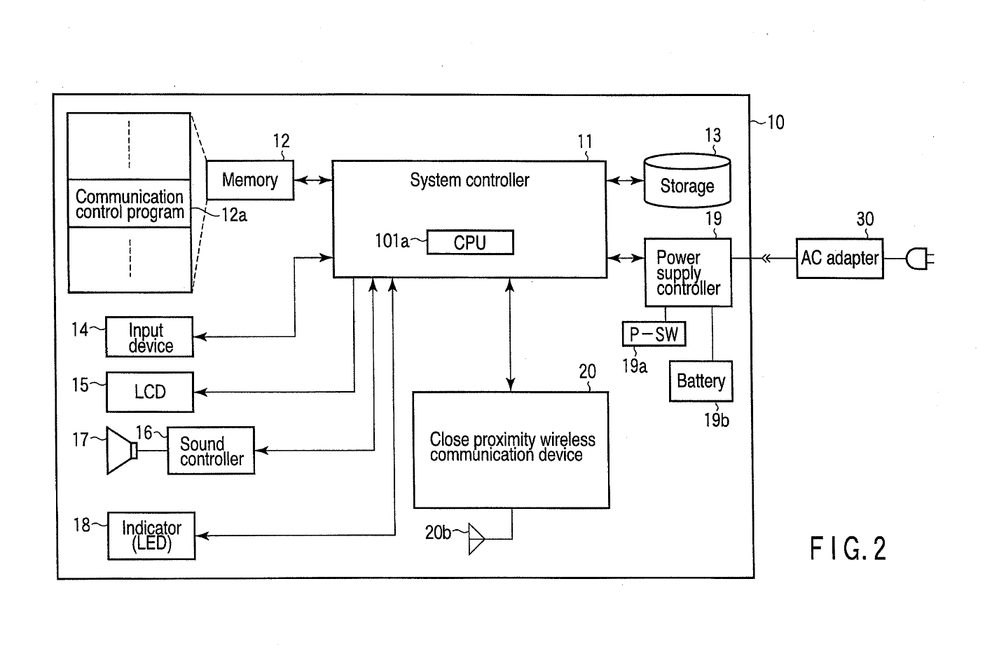

FIG. 2 shows a configuration of the electronic apparatus 10. The electronic apparatus 10 comprises a system controller 11, a memory 12, a storage device 13, an input device 14, a liquid crystal display (LCD) 15, a sound controller 16, a speaker 17, an indicator 18, a power supply controller 19, and a close proximity wireless communication device 20.

The system controller 11 controls the operations of the components of the electronic apparatus 10. The system controller 11 is connected to the memory 12, storage device 13, input device 14, LCD 15, sound controller 16, indicator 18, power supply controller 19, and close proximity wireless communication device 20. The system controller 11 comprises a CPU 101a.

The CPU 101a is a processor, which executes an operating system and various application programs/utility programs loaded from the storage device 13 to the memory 12. The application programs/utility programs include a communication control program 12a for controlling the communication operation of the close proximity wireless communication device 20. The communication control program 12a comprises a connection management tool for connecting to a server on the Internet 2 through the wireless device 50, and a player application for playing video data received from the server.

The storage device 13 comprises a hard disk drive, and a nonvolatile semiconductor memory, for example. The input device 14 is a device for inputting data and instruction to be given to the CPU 101a. The input device 14 comprises a keyboard, a plurality of pushbutton switches, or a pointing device, for example.

The LCD 15 is a display unit used as a display of the electronic apparatus 10. The sound controller 16 is a sound source circuit for outputting a sound corresponding to audio data sent from the CPU 101a. The sound controller 16 converts a digital audio data sent from the CPU 101a to an analog audio signal, and outputs the analog audio signal to the speaker 17. The speaker 17 outputs a sound corresponding to the analog audio signal.

The indicator 18 indicates the state of close proximity wireless communication (start and end of data transfer) executed by the close proximity wireless communication device 20. The indicator 18 comprises a light-emitting element such as a light-emitting diode (LED).

The power supply controller 19 supplies power to the components of the electronic apparatus 10, from an external AC adaptor 30 or an internal battery 19b installed in the electronic apparatus 10. In other words, the electronic apparatus 10 is driven from an external power supply such as a commercial alternate-current power supply, or the battery 19b. The AC adaptor 30 can be provided in the electronic apparatus 10. The power supply controller 19 turns on and off the electronic apparatus 10 according to operation of the power switch (P-SW) 19a by the user.

The close proximity wireless communication device 20 is a communication module for executing close proximity wireless communication. The close proximity wireless communication device 20 can communicate with another device (external device) having a close proximity wireless communication function, placed within a predetermined communication range from the close proximity wireless communication device 20. Wireless communication between the close proximity wireless communication device 20 and external device is possible only when these devices are in a proximity state, or the distance between these devices is within a communicable distance (e.g. 3 cm). When the close proximity wireless communication device 20 is placed close to an external device within a communicable distance, communication is possible between these devices. When the close proximity wireless communication device 20 and external device are placed in a proximity state, connection (wireless connection) between these devices is begun to be established. After the connection (wireless connection) is established between the devices, service such as playing video data described above is executed by the close proximity wireless communication between the close proximity wireless communication device 20 and external device (wireless device 50).

Close proximity wireless communication uses an induction field. Transfer Jet (trade mark) is usable as a method of close proximity wireless communication. Transfer Jet is a method of close proximity wireless communication using an ultra wide band (UWB), and realizes high-speed data transfer.

The close proximity wireless communication device 20 is connected to an antenna 20b. The antenna 20b is an electrode called a coupler, and transmits data to and receives data from an external device by means of radio signal using an induction field. When an external device is placed close to the antenna 20b within a communicable distance (3 cm), the antennas (couplers) of the close proximity wireless communication device 20 and external device are connected by an induction field, and wireless communication is possible between the close proximity wireless communication device 20 and external device. The close proximity wireless communication device 20 and antenna 20b can be realized as one module.

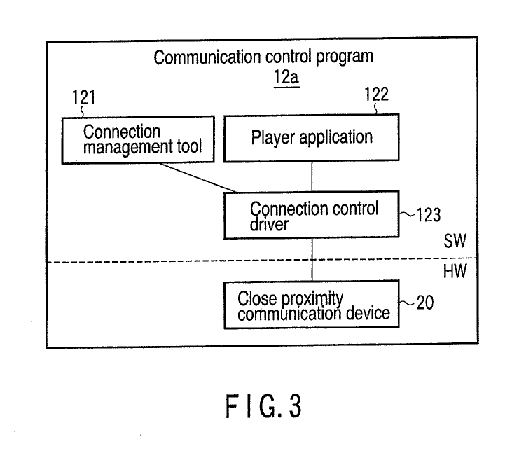

Configuration of the communication control program 12a is described with reference to FIG. 3.

The communication control program 12a comprises a connection management tool 121, a player application 122, and a connection control driver 123. Protocol stack for controlling close proximity wireless communication is largely divided into a lower layer and a higher layer. A lower layer is realized by the connection control driver 123. The connection management tool 121 and player application 122 function as a higher layer.

The connection control driver 123 is a program for controlling connection (physical connection) between the close proximity wireless communication device 20 and external device. The connection control driver 123 functions as a connection controller, which establishes connection between the wireless device 50 and close proximity wireless communication device 20 in a proximity state.

The connection control driver 123 controls connection (physical connection) between two devices (e.g. a local device A and a remote device B) in a proximity state. The local device A corresponds to the electronic apparatus 10, and the remote device B corresponds to the wireless device 50.

For example, when the device A (a communication module in the device A) is not connected, the connection control driver 123 establishes connection between the device A and device B in a proximity state. Further, the connection control driver 123 determines whether a period receiving no response from the device B exceeds a connection timeout value. When a period receiving no response from the device B exceeds the connection timeout value, the connection control driver 123 releases the connection between the device A and device B. In this embodiment, the connection timeout value used by the connection control driver 123 can be changed. The connection timeout value can be set to an infinite value or a specific value.

Even after the proximity state between the device A and device B is released, the connection between the device A and device B is not released until a period receiving no response from the device B exceeds the connection timeout value. Here, the period from the release of the proximity state between the devices A and B to the release of the connection between the devices A and B, that is, the state of the device A in the period during which data transfer by close proximity wireless communication is stopping, is called a pause state.

As in a normal connection state, in a pause state, the connection control driver 123 may start a retry timer and a connection timer, whenever wirelessly sending a message (e.g. an internet access command, a command to request to acquire video data, and other various communication control messages) to the device B. A retry timer is used to determine whether a message (data or command) is resent. When a response is received from the device B within the time indicated by the retry timeout value after a message is sent, the values of the retry timer and connection timer are reset.

On the other hand, when a response is not received from the device B within the time indicated by the retry timeout value after a message is sent, a retry timeout occurs, the message is resent, and the retry timer is restarted. The connection timer is not reset. The connection timer continues counting the time receiving no response from the device B. Until the time receiving no response from the device B exceeds a connection timeout value, the connection control driver 123 continuously resends a message (retry). When the time receiving no response from the device B exceeds the connection timeout value, a connection timeout occurs, and the devices A and B are disconnected.

In this embodiment, the connection timeout value can be changed as described above, and even after the proximity state between the devices A and B is released, the connection control driver 123 can keep the connection between the devices A and B. In other words, the connection control driver 123 can keep the connection between the devices A and B regardless of whether the proximity state is released.

The connection management tool 121 functions as a network connection controller, which connects the Web server 3 on the internet 2 through the close proximity wireless communication between the close proximity wireless communication device 20 and wireless device 50 and the wireless communication function of the wireless device 50. The function of the network connection controller establishes a communication channel (connection) between the electronic apparatus 10 and Web server 3. The connection management tool 121 inquires of the connection control driver 123 about the current connection state, and determines whether the current state of close proximity wireless communication is “connect”, “pause”, or “disconnect”. The connection management tool 121 can display the current state of close proximity wireless communication (“connect”, “pause”, or “disconnect”) on the display.

The player application 122 receives content such as video data and audio data from the Web server 3 through the close proximity wireless communication between the close proximity wireless communication device 20 and wireless device 50 and the wireless communication function of the wireless device 50, and plays the received content. Hereinafter, an explanation will be given of the case of handling video data as content.

Video data is received in certain data size units, for example. While video data is being received, the received video data is played. The player application 122 can determine whether the current state of close proximity wireless communication is “connect”, “pause”, or “disconnect” by asking the connection control driver 123 about the current connection state. When the proximity state between the close proximity wireless communication device 20 and wireless device 50 is released during playback of video data, or the current connection state is changed to “pause”, the player application 122 automatically halts playing video data (pause). While halting the playing, the player application 122 stops reception of video data. Even while the playing is being halted, the player application 122 continuously monitors the current state of close proximity wireless communication, by inquiring of the connection control driver 123 about the current connection state. When the proximity state between the close proximity wireless communication device 20 and wireless device 50 is restored, or the current connection state is changed from “pause” to “connect”, the player application 122 releases the pause, and restarts reception of video data and playback of received video data. Playing of video data is restarted from the position where the playing is halted.

Like the electronic apparatus 10, the wireless device 50 may monitor the current state of close proximity wireless communication between the wireless device 50 and electronic apparatus 10. Further, the wireless device 50 may control the communication between the wireless device 50 and the close proximity wireless communication device 20 in the electronic apparatus 10, and the communication between the wireless device 50 and external network, according to the current state of close proximity wireless communication.

In the control of the communication between the wireless device 50 and the close proximity wireless communication device 20 in the electronic apparatus 10, according to the current state of close proximity wireless communication, the wireless device 50 may (i) transmit/receive data by close proximity wireless communication, (ii) continue communication to keep the connection between the wireless device 50 and close proximity wireless communication device 20, regardless of whether the proximity state between the wireless device 50 and close proximity wireless communication device 20 is released, and (iii) release the connection between the wireless device 50 and close proximity wireless communication device 20. The wireless device 50 can set a connection timeout value for close proximity wireless communication to an infinite value or a certain specific value.

In the control of the communication between the wireless device 50 and external network, according to the current state of close proximity wireless communication, the wireless device 50 may (i) transmit data (command) to a server on an external network, and receive data (content) from the server, (ii) continue communication to keep the connection between wireless device 50 and a server on an external network, regardless of whether the proximity state between the wireless device 50 and the server is released, and (iii) release the connection between the wireless device 50 and close proximity wireless communication device 20.

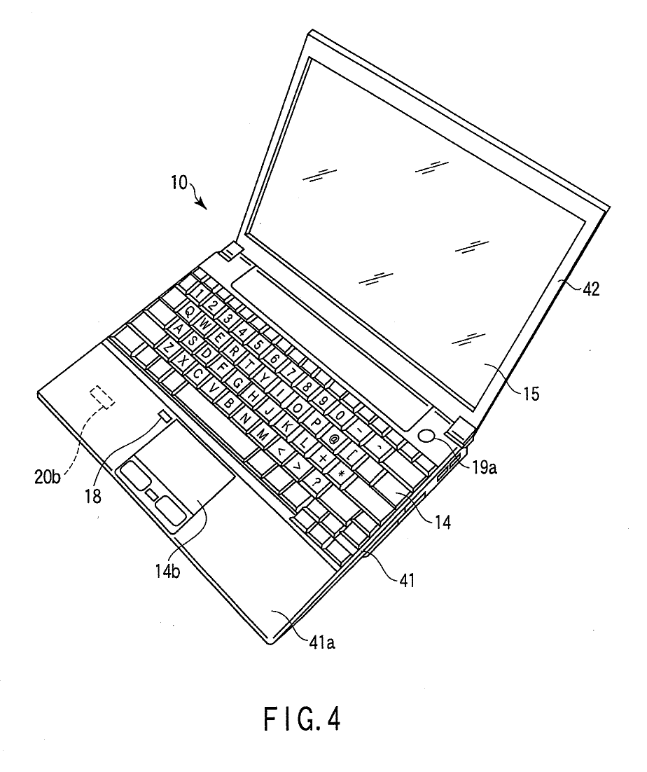

The external view of the electronic apparatus 10 will be explained with reference to FIG. 4, assuming that the electronic apparatus 10 is realized as a portable personal computer.

FIG. 4 is a perspective view showing the external view of the electronic apparatus 10. The electronic apparatus 10 comprises a main unit 41, and a display unit 42. The display unit 42 is fixed to the main unit 41 to be rotatable between the opened position where the top face of the main unit 41 is exposed, and the closed position where the top face of the main unit 41 is covered by the display unit 42. The LCD 15 is provided in the display unit 42.

The main unit 41 has a thin box-shaped case. On the top face of the case of the main unit 41, a keyboard 14a, a touch pad 14b, the indicator 18, the power switch 19a are arranged.

The top face of the main unit 41, particularly, a part of an palm rest area 51a on the top face of the main unit 41, functions as a communication surface. In other words, the close proximity wireless communication device 20 and the antenna (coupler) 20b are provided in the main unit 41, opposing to the palm rest area 51a on the top face of the main unit 41. The antenna (coupler) 20b is placed to output a radio signal (induction field) to the outside through the top face of the main unit 41 (particularly, a part of the palm rest area 41a on the top face of the main unit 41). A small area on the top face of the main unit 41 opposing to the antenna (coupler) 20b, or a small area placed above the antenna (coupler) 20b, is used as a communication position.

The user can start service such as data transfer between the electronic apparatus 10 and an external device, by placing (touching) an external device having a close proximity wireless communication function, over the communication position in the palm rest area 41a of the main unit 41.

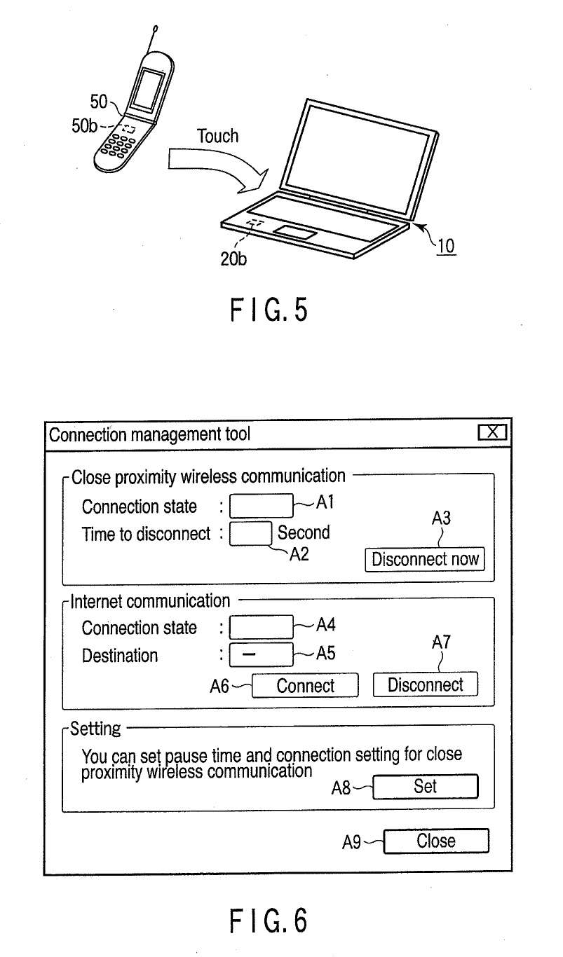

FIG. 5 shows close proximity wireless communication executed between the wireless device 50 (cell-phone) device and electronic apparatus 10. The wireless device 50 is provided with an antenna (coupler) 50b opposing to the backside. In this case, the user can start close proximity wireless communication between the wireless device 50 and electronic apparatus 10, by placing the backside of the wireless device 50 over the communication position of the palm rest area of the main unit 41 of the electronic apparatus 20 (or by placing the cell-phone 5 on the palm rest area).

FIG. 6 shows an example of a connection management screen displayed by the connection management tool 121.

The connection management tool 121 displays the connection state of close proximity wireless communication A1, time to disconnect A2, and a disconnect now button A3, on the connection management screen. As the connection state A1, one of “connect”, “disconnect”, and “pause” of close proximity wireless communication is displayed. As the time to disconnect A2, the time (timeout) to disconnect when close proximity wireless communication is halted. The disconnect now button A3 is used to disconnect close proximity wireless communication without waiting for a timeout, when close proximity wireless communication is halted. When the disconnect now button A3 is pressed, the connection management tool 121 responds to the depression, and disconnects close proximity wireless communication.

The connection management tool 121 displays the connection state of Internet communication A4, a destination A5, a connect button A6, and a disconnect button A7, on the connection management screen. In the connection state A4, one of “connect” and “disconnect” of the Internet connection, and “dial-up” is displayed. In the destination A5, an index number of a preset dial-up destination. The connect button A6 is used to establish Internet connection to a destination. When the connect button A6 is pressed, the connection management tool 121 responds to the depression, and establishes Internet connection to a destination. The disconnect button A7 is used to disconnect Internet connection to a destination. When the disconnect button A7 is pressed, the connection management tool 121 responds to the depression, and disconnect Internet connection to a destination.

Further, the connection management tool 121 displays a set button A8 to display a setup screen, and a close button A9 to close the connection management screen, on the connection management screen. When the set button A8 is pressed, the connection management tool 121 responds the depression, and displays a setup screen. When the close button A9 is pressed, the connection management tool 121 responds the depression, and closes the connection management screen.

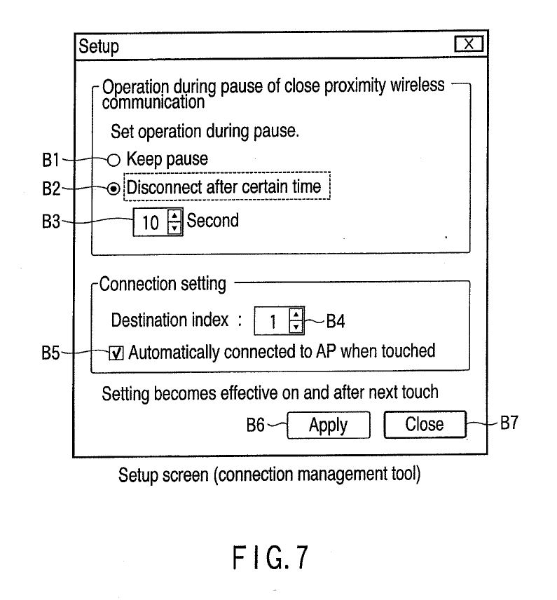

FIG. 7 shows an example of a setup screen displayed by the connection management tool 121.

The connection management tool 121 displays radio buttons B1 and B2 to specify an operation during pause of close proximity wireless communication, on the setup screen. The radio button B1 is used to keep pause of close proximity wireless communication. The radio button B2 is used to disconnect close proximity wireless communication, when the pause time exceeds a threshold value. As a threshold value, the time specified in an input box B3 (e.g. 10 seconds) is set. Therefore, when the radio button B1 is selected during pause of close proximity wireless communication, the connection management tool 121 keeps the pause of close proximity wireless communication. When the radio button B2 is selected, the connection management tool 121 disconnects the close proximity wireless communication after the expiration of the time specified in the input box B3.

The connection management tool 121 displays an input box B4 and a check box B5 to specify setting for connection, on the setup screen. The input box B4 specifies an index number (e.g. 1) of an access point (destination) to be connected. The check box B5 specifies whether to automatically connect an access point, when the device is touched. When the device is touched, and the check box B5 is selected (checked), the connection management tool 121 automatically connects (dials up) the access point.

Further, the connection management tool 121 displays an apply button B6 to apply the value specified on the setup screen, and a close button B7 to close the setup screen. When the apply button B6 is pressed, the connection management tool 121 responds to the depression, and applies the value specified on the setup screen to the connection operation. When the close button B7 is pressed, the connection management tool 121 responds to the depression, and closes the setup screen.

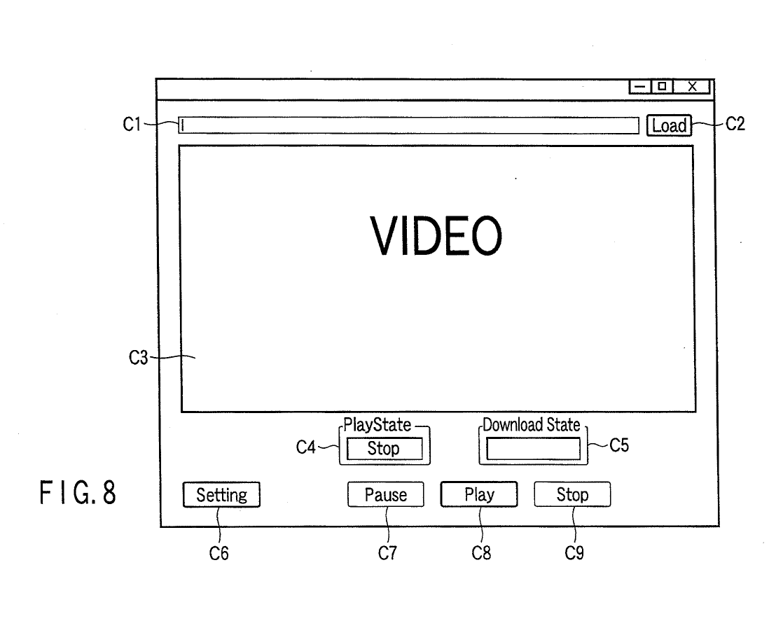

FIG. 8 shows an example of a playback screen displayed by the player application 122. The playback screen has an URL input box C1, a load button C2, a video playback area C3, a play state display C4, a download state display C5, a setting button C6, a pause button C7, a play button C8, and a stop button C9.

The URL input box C1 displays an URL indicating object video data. The load button C2 is used to start download and playback of the video data corresponding to the URL displayed in the URL input box C1. When the load button C2 is pressed, the player application 122 responds to the depression, starts download (streaming) of the video data, and starts reproduction of the received video data. The player application 122 displays the reproduced video data in the video payback area C3. The player application 122 displays the video data play state in the play state display C4. The player application 122 displays one of “play”, “stop”, and “pause” of the video data, for example, in the play state display C4. Further, the player application 122 displays the download state of the video data in the download state display C5. The player application 122 displays one of “receive”, “stop”, and “pause” of download, for example, in the download state display C5.

The setting button C6 is used to display a setup screen for download and playback of video data. When the setting button C6 is pressed, the player application 122 responds to the depression, and displays a setup screen.

The pause button C7 is used to halt playing of video data. The play button C8 is used to play stopped or halted video data. The stop button C9 is used to stop playing of video data. When the pause button C7, play button C8, or stop button C9 is pressed, the player application 122 responds to the depression, and halts, plays, or stops video data.

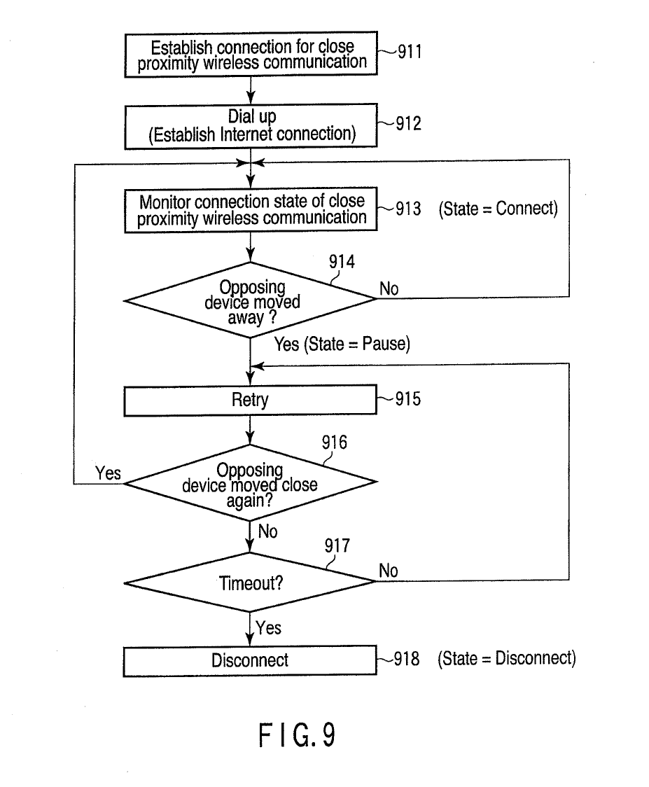

An explanation will be given of an example of procedures executed by the connection management tool 121 by cooperating with the connection control driver 123, with reference to the flowchart of FIG. 9.

The connection management tool 121 establishes connection by close proximity wireless communication between the close proximity wireless communication device 20 and wireless device 50 (block 911). The connection management tool 121 responds to that the wireless device 50 and close proximity wireless communication device 20 are moved close to each other, and placed to a proximity state, and establishes connection by close proximity wireless communication.

The connection management tool 121 dials up (connects wirelessly to a mobile telephone network) through the wireless communication function of the wireless device 50, and establishes Internet connection between the electronic apparatus 10 and Web server 3 on the Internet 2 (block 912).

The connection management tool 121 inquires of the connection control driver 123 about the current connection state, and monitors the state of close proximity wireless communication (connection) between the close proximity wireless communication device 20 and wireless device 50 (block 913). The connection state between the close proximity wireless communication device 20 and wireless device 50 upon the start of monitoring is set to “connect”. The connection management tool 121 can determine whether the current state of close proximity wireless communication is “connect”, “pause” or “disconnect”, by asking the connection control driver 123 about the current connection state.

The connection management tool 121 determines whether the wireless device 50 (an opposing device) is moved away (block 914). In other words, the connection management tool 121 determines whether the proximity state between the close proximity wireless communication device 20 and wireless device 50 is released. The connection management tool 121 determines that the wireless device 50 is moved away, when the close proximity wireless communication is disconnected, for example. When the wireless device 50 is not moved away (the proximity state is not released) (No in block, 914), the connection management tool 121 returns to block 913, and continues monitoring the connection state by close proximity wireless communication.

When the wireless device 50 is moved away (the proximity state is released) (Yes in block 914), the connection control driver 123 retries to resend a transmission message (command) under the control of the connection management tool 121 (block 915). In other words, the connection management tool 121 resends a message such as a command through the connection control driver 123. When the wireless device 50 is moved away, the connection to the wireless device 50 is set to “pause”.

The connection management tool 121 determines whether the wireless device 50 is moved closer again (block 916). In other words, the connection management tool 121 determines whether the proximity state between the wireless device 50 and close proximity wireless communication device 20 is restored. The connection management tool 121 determines that the wireless device 50 is moved close again, when the close proximity wireless communication is connected, for example. When the wireless device 50 is moved close again (the proximity state is restored) (Yes in block 916), the connection management tool 121 returns to block 913, and continues monitoring the connection state by close proximity wireless communication.

When the wireless device 50 is not moved close (the proximity state is not restored) (No in block 916), the connection management tool 121 determines whether a connection timeout occurs (block 917). For example, the connection management tool 121 determines whether a period receiving no response from the wireless device 50 exceeds a threshold value (a connection timeout value). When a connection timeout does not occur (No in block 917), the connection management tool 121 returns to block 915, and retries. When a connection timeout occurs (Yes in block 917), the connection management tool 121 releases (disconnects) the connection between the close proximity wireless communication device 20 and wireless device 50. In other words, the connection state between the close proximity wireless communication device 20 and wireless device 50 is set to “disconnect”.

According to the above procedures, the connection management tool 121 can keep the connection between the devices, even after the proximity state between the close proximity wireless communication device 20 and wireless device 50 is released.

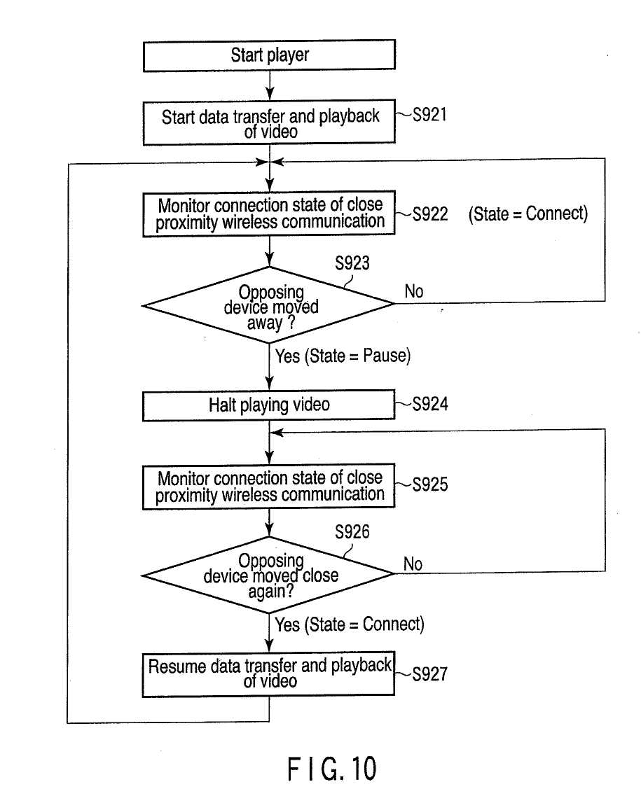

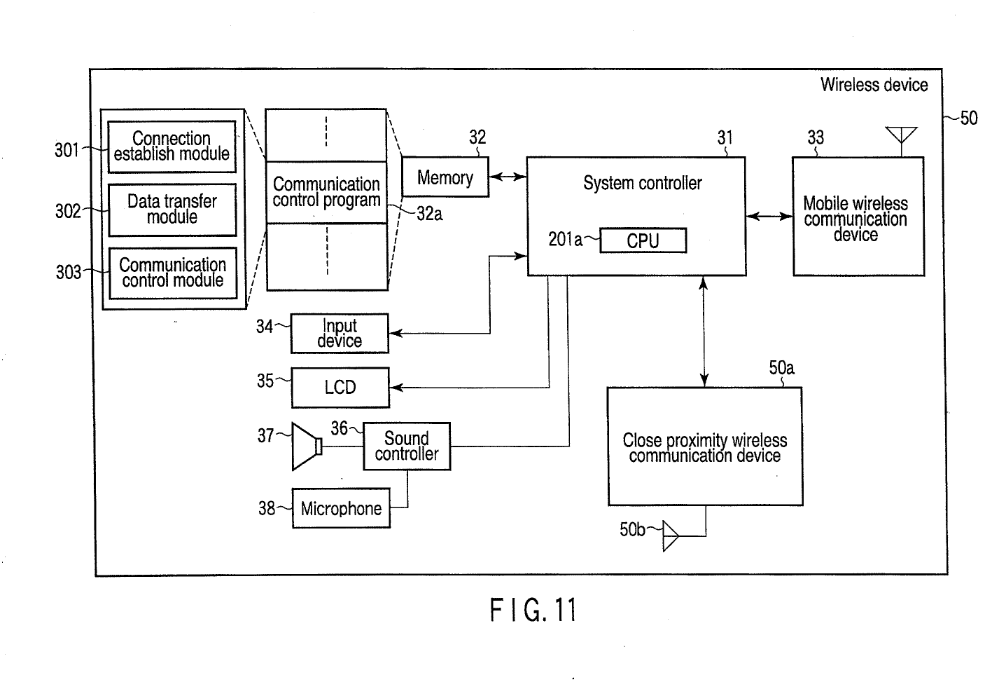

FIG. 10 is a flowchart showing an example of procedures executed by the player application 122. As described above, the player application 122 receives video data from the Web server 3 through the close proximity wireless communication between the close proximity wireless communication device 20 and wireless device 50 and the wireless communication function of the wireless device 50, and plays the received video data.

The player application 122 receives video data from the Web server 3, and starts an operation to play the video data (block 921). In block 921, the player application 122 periodically sends the Web server 3 a command to request to acquire video data. While receiving video data, the player application 122 plays the received video data. The player application 122 inquires of the connection control driver 123 about the current connection state, and monitors the state (connection) of close proximity wireless communication between the close proximity wireless communication device 20 and wireless device 50. The connection (state) between the close proximity wireless communication device 20 and wireless device 50 upon the start of monitoring is set to “connect”. The player application 122 can determine whether the current state of close proximity wireless communication is “connect”, “pause” or “disconnect” by the above monitoring.

The player application 122 determines whether the wireless device 50 (an opposing device) is moved away (block 923). In other words, the player application 122 determines whether the proximity state between the close proximity wireless communication device 20 and wireless device 50 is released. The player application 122 determines that the wireless device 50 is moved away, when the close proximity wireless communication is in the “pause” state, for example. When the wireless device 50 is not moved away (the proximity state is not released) (No in block 923), the player application 122 returns to block 922, and continues monitoring the state of close proximity wireless communication.

When the wireless device 50 is moved away (the proximity state is released) (Yes in block 923), the player application 122 halts playing video data (block 924). At this time, the player application 122 acquires the position (pause position) where the playing video data is halted. When the wireless device 50 is moved away, the connection to the wireless device 50 is set to “pause”. In the pause period, reception and playback of video data by the player application 122 is halted. In the pause period, the player application 122 needs not to receive content such as video data from the Web server 3, and does not send the wireless device 50 a command to request the Web server 3 to acquire content such as video data. Therefore, even if data transfer by close proximity wireless communication is temporarily stopped, the operation of the player application 122 is not adversely affected.

The player application 122 monitors the state of close proximity wireless communication between the close proximity wireless communication device 20 and wireless device 50 (block 925).

The player application 122 determines whether the wireless device 50 is moved close again (block 926). In other words, the player application 122 determines whether the proximity state between the wireless device 50 and close proximity wireless communication device 20 is restored. The player application 122 determines that the wireless device 50 is moved close again, when the close proximity wireless communication is connected, for example. When the wireless device 50 is moved close again (the proximity state is restored) (Yes in block 926), the player application 122 resumes reception and playback of video data (block 927). At this time, the player application 122 resumes reception and playback of video data from the point where the playing of video data is halted, based on the pause position where the playing of video data is halted. At this time, the connection between the close proximity wireless communication device 20 and wireless device 50 is set to “connect”.

When the wireless device 50 is not moved close (the proximity state is not restored) (No in block 926), the player application 122 returns to block 925, and continues monitoring the connection state by close proximity wireless communication.

According to the above procedures, the player application 122 can respond to the restoration of the proximity state, and resume reception and playback of video data, even after the proximity state between the close proximity wireless communication device 20 and wireless device 50 is released.

As described above, according to this embodiment, playing of content such as video data is automatically halted in response to release of the proximity state between the electronic apparatus 10 and wireless device 50, and thus a communication error does not occur, and content such as video data can easily be resumed. This prevents degradation in the operability of close proximity wireless communication caused by a temporary release of proximity state.

The function of the connection control program in this embodiment can also be realized by a hardware module.

In the above description, the procedures executed by the electronic apparatus 10 are mainly explained. The wireless device 50 may control communication between the wireless device 50 and close proximity wireless communication device 20, and communication between the wireless device 50 and an external network, according to the states of close proximity wireless communication. Further, the wireless device 50 may halt transfer of content, when the proximity state between the electronic apparatus 10 and wireless device 50 is temporarily released during transfer of content. Transfer of content may be resumed after the proximity state is restored.

Hereinafter, an example of configuration of the wireless device 50 will be explained with reference to FIG. 11.

The wireless device 50 comprises a system controller 31, a memory 32, a mobile wireless communication device 33, an input device 34, a liquid crystal display (LCD) 35, a sound controller 36, a speaker 37, a microphone 38, and a close proximity wireless communication device 50a.

The system controller 31 controls the operations of the components of the wireless device 50. The system controller 31 comprises a CPU 201a.

The CPU 201a is a processor to execute programs stored in the memory 32. The programs include a communication control program 32a, which controls close proximity wireless communication between the electronic apparatus 10 and wireless device 50, and wireless communication between the electronic apparatus 10 and an external network. The communication control program 32a is a service program, which executes data transfer between the electronic apparatus 10 and a server on an external network, by using close proximity wireless communication and mobile wireless communication. The communication control program 32a executes data transfer between the electronic apparatus 10 and the server on the external network, through close proximity wireless communication between the wireless device 50 and electronic apparatus 10, and wireless communication between the wireless device 50 and an external network. The communication control program 32a monitors the current state of close proximity wireless communication between the wireless device 50 and electronic apparatus 10. The communication control program 32a controls communication between the wireless device 50 and electronic apparatus 10, and communication between the wireless device 50 and the server on the external network through the mobile communication network 1.

The communication control program 32a can keep the connection between the wireless device 50 and electronic apparatus 10, and the connection between the wireless device 50 and the server on the external network, even after the proximity state between the wireless device 50 and electronic apparatus 10 is released. Therefore, when the proximity state between the wireless device 50 and electronic apparatus 10 is restored, the wireless device 50 can resume data transfer between the wireless device 50 and the server on the external network, and data transfer between the wireless device 50 and electronic apparatus 10.

The communication control program 32a includes a connection establish module 301, a data transfer module 302, and a communication control module 303. The connection establish module 301 establishes connection between the electronic apparatus 10 and the close proximity wireless communication device 50a in the wireless device 50, which are in the proximity state. The data transfer module 302 connects the Web server 3 on the Internet 2 through the mobile communication network 1, and wirelessly transfers the content received from the Web server 3 to the electronic apparatus 10 through close proximity wireless communication. The communication control module 303 monitors the proximity state between the electronic apparatus 10 and the close proximity wireless communication device 50a in the wireless device 50, during transfer of content. When the proximity state is released during transfer of content, the communication control module 303 may halt the transfer of content, while keeping the connection between the electronic apparatus 10 and the close proximity wireless communication device 50a in the wireless device 50, and the connection between the wireless device 50 and Web server 3. In this case, the communication control module 303 may halt reception of content from the Web server 3, for example. When the proximity state is restored, the communication control module 303 resumes reception of content from the Web server 3, and wirelessly transfers the content received from the Web server 3 to the electronic apparatus 10 through close proximity wireless communication.

The mobile wireless communication device 33 is a wireless communication module, which executes wireless communication with the mobile communication network 1, by using a mobile wireless communication method such as Global System for Mobile Communication (GSM). The input device 34 is a device to input data and instruction to be given to the CPU 201a. The input device 34 is realized by a keyboard, a plurality of pushbutton switches, or a pointing device, for example. The LCD 35 is a display unit used as a display of the wireless device 50. The sound controller 36 is a sound source circuit to output a sound corresponding to audio data sent from the CPU 201a. The sound controller 36 converts a digital audio signal sent from the CPU 201a to an analog audio signal, and outputs the analog audio signal to the speaker 77. The speaker 77 outputs a sound corresponding to the analog audio signal. The sound controller 36 converts an analog audio signal input from the microphone 38 into a digital audio signal, and sends the digital audio signal to the CPU 201a. The close proximity wireless communication device 50a is a communication module for executing close proximity wireless communication. The close proximity wireless communication device 50a is connected to an antenna 50b. The antenna 50b is an electrode called a coupler, and transmits/receives data to/from an external device by means of a radio signal using an induction field.

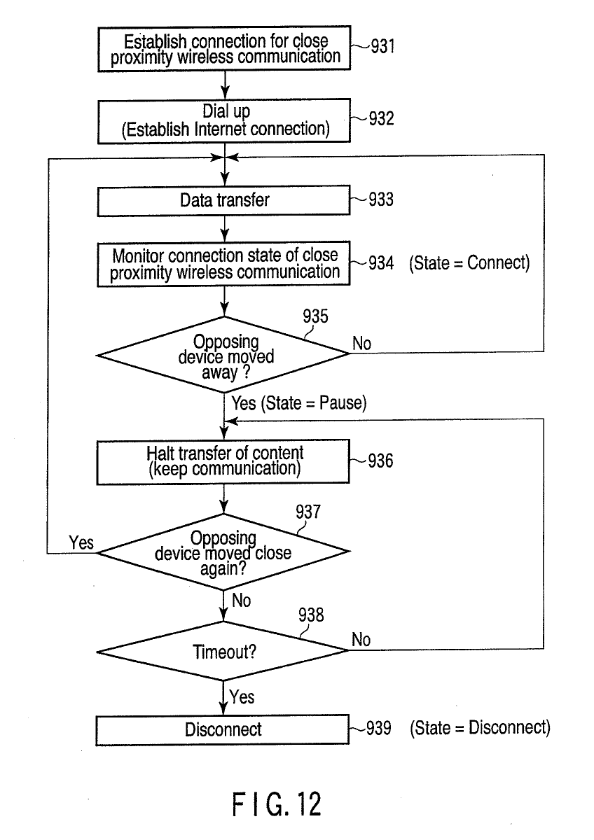

An explanation will be given of communication control procedures executed by the communication control program 32a of the wireless device 50, with reference to FIG. 12.

The communication control program 32a establishes connection by close proximity wireless communication between the close proximity wireless communication device 20 in the electronic apparatus 10 and the close proximity wireless communication device 50a in the wireless device 50 (block 931). The communication control program 32a responds to that the electronic apparatus 10 and wireless device 50 are moved close to each other, and set to the proximity state, and establishes connection by close proximity wireless communication.

The communication control program 32a responds to Internet connection request from the electronic apparatus 10, and establishes Internet connection with the Web serve 3 on the Internet 2 through the mobile communication network 1 (block 932).

The communication control program 32a executes data transfer (block 933). In block 933, the communication control program 32a transfers a command (a command to request to acquire content) from the electronic apparatus 10 to the Web server 3, receives content from the Web server 3, and transfers the received content to the electronic apparatus 10. The communication control program 32a monitors the state (connection state) of close proximity wireless communication between the electronic apparatus 10 and wireless device 50, or the state (connection state) of close proximity wireless communication between the close proximity wireless communication device 20 and close proximity wireless communication device 50a (block 934). The connection state between the electronic apparatus 10 and wireless device 50 upon the start of monitoring is set to “connect”. The communication control program 32a can determine whether the current state of close proximity wireless communication is “connect”, “pause” or “disconnect”.

The communication control program 32a determines whether the electronic apparatus (an opposing device) is moved away (block 935). In other words, the communication control program 32a determines whether the proximity state between the electronic apparatus 10 and wireless device 50 is released. The communication control program 32a determines that the electronic apparatus 10 is moved away from the wireless device 50, when the state of close proximity wireless communication is “pause”, for example. When the electronic apparatus 10 is not moved away (the proximity state is not released) (No in block 935), the communication control program 32a returns to block 933, and continues data transfer and monitoring the connection state by close proximity wireless communication.

When the electronic apparatus 10 is moved away (the proximity state is released) (Yes in block 935), the communication control program 32a halts transfer of content, while keeping the connection between the electronic apparatus 10 and wireless device 50, and the connection between the wireless device 50 and Web server 3 through the mobile communication network 1 (block 936). In block 936, the communication control program 32a halts reception of content from the Web server 3, for example. When the proximity state between the electronic apparatus 10 and wireless device 50 is released, the connection state between the electronic apparatus 10 and wireless device 50 is set to “pause”.

The communication control program 32a determines whether the electronic apparatus 10 is moved close again (block 937). In other words, the communication control program 32a determines whether the proximity state between the electronic apparatus 10 and wireless device 50 is restored. The communication control program 32a determines that the proximity state between the electronic apparatus 10 and wireless device 50 is restored, when the close proximity wireless communication is connected, for example. When the proximity state between the electronic apparatus 10 and wireless device 50 is restored, (Yes in block 937), the communication control program 32a returns to block 933, and continues transfer of content and monitoring the connection state by close proximity wireless communication.

When the proximity state is not restored (No in block 937), the communication control program 32a determines whether a connection timeout occurs (block 938). For example, the communication control program 32a determines whether a period receiving no response from the electronic apparatus 10 exceeds a threshold value (a connection timeout value). When a connection timeout does not occur (No in block 938), the communication control program 32a returns to block 936.

When a connection timeout occurs (Yes in block 938), the communication control program 32a releases (disconnects) the connection between the electronic apparatus 10 and wireless device 50, and releases (disconnects) the connection between the wireless device 50 and Web server 3 through the mobile communication network 1 (block 939). In other words, the connection state between the electronic apparatus 10 and wireless device 50 is set to “disconnect”.

According to the above procedures, even if the proximity state between the electronic apparatus 10 and wireless device 50 is temporarily released during transfer of content such as video data, due to a displacement of devices or movement of the wireless device 50 by the user, transfer of content from a server to the electronic apparatus 10 can easily be resumed. While the proximity state is being temporarily released, transfer of content by the wireless device 50 is halted, and data is not lost.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a communication device having a close proximity wireless communication function;
a first controller configured to establish connection between a wireless device and the communication device which are in a proximity state;
a second controller configured to connect the electronic apparatus to a server on an external network through the close proximity wireless communication function and a wireless communication function of the wireless device; and
a player configured to play a content received from the server through the close proximity wireless communication function and the wireless communication function of the wireless device, to halt playing the content when the proximity state is released during the playing, and resume playing the content when the proximity state is restored.

2. The electronic apparatus of claim 1, wherein the player is configured to halt reception and playback of the content when the proximity state is released, and to resume reception of the content and playing the content when the proximity state is restored.

3. The electronic apparatus of claim 1, wherein the player is configured to monitor the close proximity wireless communication between the wireless device and the communication device in order to determine whether the proximity state is released while the content is played.

4. The electronic apparatus of claim 3, wherein the player is configured to monitor the close proximity wireless communication between the wireless device and the communication device in order to determine whether the proximity state is released while playing the content is halted.

5. The electronic apparatus of claim 1, wherein the first controller is configured to keep connection between the wireless device and the communication device, regardless of whether the proximity state is released.

6. The electronic apparatus of claim 1, wherein the wireless device is configured to keep connection between the wireless device and the server, regardless of whether the proximity state is released.

7. The electronic apparatus of claim 1, wherein the wireless device is configured to be wirelessly connected to a mobile communication network by the wireless communication function.

8. The electronic apparatus of claim 1, wherein the wireless device comprises:
a transfer device configured to transfer the content received from the server to the electronic apparatus through the close proximity wireless communication; and
a communication control device configured to monitor the proximity state, to establish connection between the electronic apparatus and the communication device, when the proximity state is released during transfer of the content, to halt transfer of the content while keeping the connection between the wireless device and the server, and to resume transfer of the content, when the proximity state is restored.

9. A wireless device connectable to a mobile communication network, the wireless device comprising:
a communication device having a close proximity wireless communication function;
a connection establishing device configured to establish connection between an electronic apparatus and the communication device which are in a proximity state;
a transfer device configured to connect the wireless device to a server on an external network through the mobile communication network, and to transfer the content received from the server to the electronic apparatus through the close proximity wireless communication; and
a controller configured to monitor the proximity state, to halt transfer of the content while keeping the connection between the electronic apparatus and the communication device and a connection between the wireless device and the server when the proximity state is released during transfer of the content, and to resume transfer of the contents when the proximity state is restored.

10. A communication control method comprising:
establishing connection between a wireless device and a communication device having a close proximity wireless communication function which are in a proximity state;
connecting the communication device to a server on an external network through the close proximity wireless communication function and a wireless communication function of the wireless device;
playing a content received from the server through the close proximity wireless communication function and the wireless communication function of the wireless device;
halting playing the content when the proximity state is released during the playing; and
resuming playing the content when the proximity state is restored.

11. The communication control method of claim 10, wherein
the playing comprises:
receiving a content from the server through the close proximity wireless communication function and a wireless communication function of the wireless device, and
playing the received content,
the halting playing comprises halting reception and playback of the content in response to release of the proximity state, and
the resuming playing comprises resuming reception and playback of the content when the proximity state is restored.
